(19) United States
(12) Patent Application Publication
(10) Pub. No.: US 2010/0146918 A1
(43) Pub. Date: Jun. 17, 2010

(54) Method and external, disposable filter for home computers

(76) Inventor: Shai Brosh, Tel Aviv (IL)

Correspondence Address: SHAI BROSH, P.O.Box 29746, Tel Aviv, 61297, IL

(21) Appl. No.: 12/656,804

(22) Filed: Feb. 17, 2010

Related U.S. Application Data
(63) Continuation of application No. PCT/IL2008/001134, filed on Aug. 18, 2008.

(30) Foreign Application Priority Data
Aug. 22, 2007 (IL) 185431

(51) Int. Cl. B01D 50/00; B05D 1/02

(52) U.S. Cl. 55/385.4; 427/421.1

(57) ABSTRACT

The present invention is a disposable filter made of mesh or fabric, as is customary in the sector, and which is designed to be affixed to the air inlet or outlet aperture of a home computer casing. The filter can be sold in a kit that includes one or more said filters along with a tube or standard container of non-drying adhesive. The product is also designed for use on other electronic and electrical appliances.

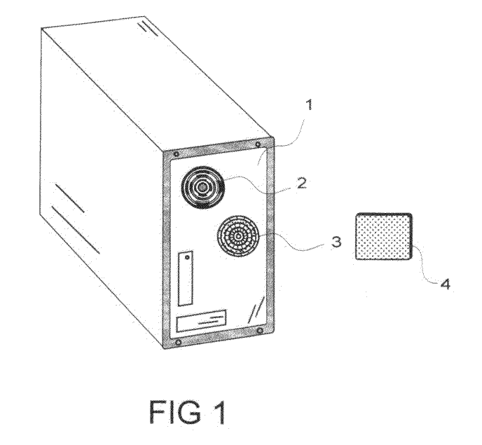

### RELATED APPLICATIONS

this application is a continuation of PCT Application No. PCT/IL2008/001134 which itself claims priority to Israeli application no. 185431 filed on 22 Aug. 2007.

### TECHNICAL FIELD

The present invention is a disposable filter designed for installation either on a home computer casing's air inlet or outlet aperture. The filter can be sold as part of a kit that contains one or more said filters together with a tube or standard container of non-drying adhesive.

### BACKGROUND OF THE INVENTION

The general public uses computers and there is a home computer in practically every office and home today. The casing of the home computer is usually equipped with at least two ventilation apertures: one for the inlet of air from the room into the computer casing and another for the outlet of air from the casing to the room. A ventilator, located within the casing and installed adjacent to the air inlet aperture, sucks air from the room into the casing. The purpose of ventilating the computer is to prevent over-heating of the computer components, which may be damaged and malfunction as a result of such over-heating.

Since rooms in most buildings, especially in residential homes, are not sterile (as opposed to special computer rooms in large organizations and institutions) and contain dust, the dust accumulates over time on the air inlet and outlet apertures, and even worse, a great amount of dust penetrates into the computer's casing. The dust that penetrates into the casing settles on the computer components, and when combined with humidity in particular, leads to electrical short-circuits and damage to computer components within the casing.

In order to prevent penetration of dust, several measures and methods have been developed based on disposable filters made of various kinds of fabrics or polymers. Due to the fact that the said advertised methods and measures are ineffective, they have not gained commercial application, at least as far as the applicants know. One measure known to the applicants includes a fabric filter that is inserted into a metal frame that is connected or attached to the air inlet or outlet aperture of the computer's casing. The cumbersomeness of the means by which the filter is attached to or on the air apertures prevents any practical option of implementing this measure.

A second measure known to the applicants is a fabric filter to which a strip or sheet of two-sided cellotape is applied or to which adhesive is pre-applied on one side of the fabric. Due to the problematic nature of affixing the two-sided cellotape to the filter or to pre-application of adhesive to the fabric and the high cost of production, this measure has not been implemented either.

The invention, subject of the present application, is an effectively implemented measure and method that provides a simple and easy solution to prevent penetration of dust into home computer casings.

### THE INVENTION

The product, subject of the invention, is a disposable fabric filter that can be affixed over the air inlet and/or outlet apertures of the computer casing. The method for applying the invention is by use of an non-drying adhesive that is applied to the casing body or to the filter before its application to the ventilation aperture.

Using non-drying adhesive enables to easily remove the disposable filter from the ventilation aperture even after a long time. The combination between the product and the method can be implemented by selling a kit that includes one or several disposable filters along with a container or tube of non-drying adhesive.

The recommended adhesive for use with the present invention is, for instance adhesive made by UHU GmbH & Co. KG, although the method can be in fact implemented using any non-drying adhesive available in the market today or in the future. There is currently a broad variety of fabric filters on the market that would be effective for the implementation of the invention, and which are familiar to anyone involved in this sector.

The invention can be implemented commercially by selling a kit that includes one or several disposable filters with or without a tube or container of non-drying adhesive. A more efficient implementation of the invention could be to add filters to the kit that can be cut to various sizes according to the shape and size of the ventilation aperture designated to be covered with a filter.

A possible implementation of the invention, subject of the present application, is a filter on which non-drying adhesive is applied, or a filter to which two-sided cellotape is applied in a criss-cross pattern or with multiple holes, so as to enable unobstructed air flow.

The invention, subject of the present application, can also serve to protect other electronic and electrical appliances, other than computers, that have air inlet and/or outlet apertures.

The product, subject of the invention, is a disposable fabric filter that can be applied over air inlet and/or outlet apertures of computer casings and/or of other electric and electronic appliances.

The fabric can be polyester or viscose or any other material designated to filter or clean, such as the cleaning fabric (weighing 80 mg.) made by SpanTech Ltd.

The implementation method of the invention can include use of liquid adhesive, preferably water based, that is sprayed on the filter (using a spraying device, such as a spray gun and compressor). The sprayed droplets of adhesive adhere to the fabric's fibers but do not clog up the spaces between the fibers, so that the filtering capacity of the fabric is not compromised. The said adhesive should enable the user to easily remove the filter from the body of the device (computer or any other appliance) to which it is applied.

After spraying the adhesive on the fabric, it should be covered with silicon paper and cut into the required size for marketing to the public.

### THE DRAWINGS

The drawing attached to the present application is not intended to limit the scope of the invention and the method of its application. The drawing is intended only to illustrate the invention and constitutes only one out of many possible ways of its application.

Drawing No. 1: Drawing No. 1 depicts the back of the home computer casing (1) that includes an air outlet aperture (2) and an air inlet aperture (3). The drawing also shows the filter sheet (4).

What is claimed:

1. A disposable filter, made of fabric or polymer or any other material, that is designed to be affixed over the air inlet or outlet aperture of a home computer casing.

2. A kit that includes one or more of the filters described in claim No. 1.

3. A kit that includes one or more of the filters described in claim No. 1 as well as non-drying adhesive.

4. The kit described in claim No. 3, whereby the adhesive is provided in a receptacle such as a tube or container.

5. A filter as described in claim No. 1 with pre-applied non-drying adhesive.

6. A filter as described in claim No. 1, to which two-sided cellotape is applied in a criss-cross pattern or with multiple holes, so as to enable unobstructed air flow

7. A disposable fabric filter with adhesive, designed to be applied over the air inlet or outlet apertures of personal computer casings or computer casings or electric or electronic appliances.

8. The filter described in claim No. 7, whereby the said fabric is made of polyester or viscose.

9. The filter described in claim No. 7, whereby the said adhesive is applied to the fabric's fibers only and not to the spaces between them.

10. The filter described in claims Nos. 7-9, whereby the side with the adhesive is covered with silicon paper designed to be removed prior to application of filter.

11. A method of applying adhesive to a fabric used as a disposable filter that is designed to be applied over the air inlet or outlet apertures of personal computer casings or computer casings or electric or electronic appliances, including use of liquid adhesive that is sprayed on the fabric using a spraying device.
